(19) United States
(12) Patent Application Publication
(10) Pub. No.: US 2002/0099475 A1
(43) Pub. Date: Jul. 25, 2002

(54) Method and device for vibration control

(76) Inventors: Ronald Spangler, Arlington, MA (US); Robert Jacques, Andover, MA (US); Kenneth Lazarus, Concord, MA (US)

Correspondence Address: TESTA, HURWITZ & THIBEAULT, LLP, HIGH STREET TOWER, 125 HIGH STREET, BOSTON, MA, 02110, US

(21) Appl. No.: 09/968,180

(22) Filed: Oct. 1, 2001

Related U.S. Application Data
(60) Provisional application No. 60/250,503, filed on Dec. 1, 2000.

(51) Int. Cl. G05B 13/00; G01M 1/38; G05B 15/00; G05B 21/00; G05D 23/00

(52) U.S. Cl. 700/280; 700/56; 700/60

(57) ABSTRACT

A motion control system is provided which optimizes the desired motion of a structure being controlled by the system. The system may be used in conjunction with existing structural control systems, or replace such structural control systems entirely. Optimization of a desired motion occurs by applying a mathematical controller to a theoretical desired motion, the controller optimizing the desired motion by taking into account one or more state parameters.

### CROSS REFERENCE TO RELATED APPLICATIONS

This application claims the benefit of U.S. Application No. 60/250,503, filed Dec. 1, 2000, the disclosure of which is hereby incorporated by reference.

### FIELD OF THE INVENTION

The invention relates generally to devices for, and methods of, precisely and optimally controlling the motion of a structure, such as a lithography stage.

### BACKGROUND OF THE INVENTION

The ability to accurately control motion of a structure in three-dimensional space, or to control motion of one structure relative to another structure in a given space, poses a problem of significant technological and economic consequence to many manufacturing applications, like those used to fabricate semiconductor chips, printed circuit boards, liquid crystal displays, and thin film devices. Such operations often employ specialized structures, such as lithography stages, laser light sources, metrology stages, pick-and place-equipment, wafer-handling robots, gantry/head assemblies, linear motors, photoimaging systems, and etching systems, to manufacture and inspect these often-delicate and sensitive products.

These structures may, while in operation, be required to move to specific points in space, whether to an absolute coordinate or to a point defined in relation to another point, such as another structure. By way of example, it may be desired for a stage carrying a wafer to move to a precisely aligned point with respect to a camera so that the wafer may be visually inspected for defects. Because structures such as these typically operate within specifically calibrated, relatively fault-intolerant operational ranges of movement, and because the movements themselves must be precisely and efficiently timed and executed, methods and devices which allow for precise and optimized control would present a welcome opportunity to improve such manufacturing and inspection processes.

One application of the optimal motion control systems according to the invention arises in the semi-conductor chip manufacturing industry. As chip-making technology has advanced, for example, through the use of advanced photolithography lasers such as those sold by Cymer, Inc. of San Diego, Calif., chip throughput requirements have also increased. One consequence of the increased requirements has been a larger positioning bandwidth of equipment, such as photolithography stages. However, with greater bandwidth has come increases in the attendant motion control issues. Here again, the need for devices and methods that allow for highly precise and optimized control is keenly felt.

By “optimized” what is meant is that at least one parameter associated with the desired motion of a structure is either minimized or maximized, or driven to some other desired condition, depending on the parameter chosen and the result desired. For example, if the parameter to be optimized is the length of time required for a particular movement, then an optimized control system would ensure that a structure moves from a first point to a second point in the least amount of time. A parameter may also be optimized with respect to one or more other parameters, and thus, not necessarily minimized or maximized.

One skilled in the art will appreciate, of course, that many such state parameters, other than solely the position of one part of the structure as a function of time, are associated with the controlled movement of a structure, and that one or more of these parameters may come into play when optimizing movement. For example, for a structure to move from a first point to a second point, the path of the motion must be predicted, as well as when the motion should be initiated and stopped. Other state parameters might include the position, velocity and acceleration with which the structure should move at various points during the motion (either instantaneously or as a function of time), the temperature of the structure, vibration of the structure (if any), the power consumption of the control system, and the physical environment in which the structure operates. Such control processes could also take into account certain “real-world” factors, such as the operating tolerances of the moving parts (e.g., motors, servos, and the like), and the reaction time between issuance of a command, such as “move” or “stop,” and the actual implementation of the command. Unknowns in plant dynamics and unforeseen disturbances to the system being controlled could be taken into account by updating the controller or control parameters. Moreover, uncertainty in the dynamic behavior of a structure, such as a lithography stage, and the impact upon those dynamics caused by changes in equipment configuration, mass distribution, and aging of equipment, subsystems, or components, all might be considered in an optimized motion control system. It is worth mentioning that, as used herein, the phrase “state parameters” is intended to mean the set of information used to govern the motion of the structure being controlled. Thus, in a simple case, position might be the state parameter and be used to generate the spatial path through which a structure should move, while in a more complex case, state parameters might include (or at least take into account) many different types of information, such as those mentioned above.

One class of control systems uses a mathematically generated controller to model and command a structure. The controller often times is generated from gathered data regarding the behavior of a structure, such as may be obtained from sensors alone, or sensor-actuator pairings. Existing control systems typically employ single-input, single-output PID controllers, making them poorly suited for dynamically complex multi-input, multi-output systems typical of semiconductor manufacturing equipment. Manufacturing equipment often requires more than about 16, and sometimes as many as 32 or more, states to accurately model the system and to control it adequately. While some work has been done in the area of controllers for multivariable systems that use non-linear curve fitting to generate and optimize system models to frequency response measurements, that work has been generally limited to large flexible structures, such as spacecraft, and used several very high powered computers, including a Cray supercomputer, to implement the algorithms. In addition, the prior work required the creation of unique mathematical filters for every given system configuration, which in turn required the services of a computer programmer to effectively create new software unique to any given control situation. As a result, prior attempts to optimize and tune, for example, a generated desired motion in an off-line scenario have required large amounts of experimental data and significant amounts of processing time at uncommon processing speeds to achieve results. Such methods, using specialized equipment and expertise, proves to be impractical in a typical manufacturing setting for all but the most time- and cost-insensitive applications.

It would thus be desirable to have devices and methods for precisely controlling motion of a structure in an optimal manner, by optimizing one or multiple state parameters, either absolutely, i.e., motion from one coordinate to another, or relatively, i.e., motion defined by distances (or other parameters) from, or with respect to, another point or structure. Optionally, such control could optionally be adaptive and/or self-tuning to ensure continued optimal system performance.

### SUMMARY OF THE INVENTION

In accordance with the present invention, there are provided systems and methods that address the shortcomings of prior motion control devices and methods.

Thus, according to one aspect of the invention, a system is provided for optimally controlling motion of a structure, when the structure moves from one point to another point in a defined space.

According to another aspect of the invention, a system is provided for optimally controlling motion of a structure, when the structure moves from a first point to a second point, where the second point is defined in relation to a third point, such as a second structure.

According to another aspect of the invention, an optimal controller is provided which adjusts one or more state parameters to ensure optimized motion of a structure.

According to yet another aspect of the invention, an optimal motion controller is provided that is tuned so that the optimization of one or more state parameters is based upon relatively recent and accurate system models.

According to another aspect of the invention, systems are provided for interfacing with existing motion control modules to optimize one or more state parameters of a structure being controlled.

### BRIEF DESCRIPTION OF THE DRAWINGS

FIG. 1 is a drawing illustrating one possible scenario where a motion control system according to the invention could be employed, namely in moving a robotic arm carrying a wafer from one point in space to another point.

FIG. 2 is a drawing illustrating another possible scenario where a motion control system according to the invention could be employed, namely in moving a stage carrying a wafer from a first point to a second point, where the second point is defined in relation to a camera.

FIG. 3 is a schematic of one possible motion control system according to the invention, including blocks representing certain logical and hardware components of the control system.

FIG. 4 illustrates an example of an actuator to sensor model which could be used to produce the problem specification used in a controller for a typical lithography stage, as is used in the manufacture of semiconductor wafers.

FIG. 5 illustrates one possible application of the invention, namely a fabricating system being controlled by a motion control system according to the invention.

FIG. 6 illustrates another possible application of the invention, namely a lithography stage have a wafer stage and a wafer stage base, the motion of which could be controlled using control systems according to the invention.

FIG. 7 illustrates the improvement in control obtained by using a Multiple Input, Multiple Output (MIMO) controller according to the invention.

FIG. 8 illustrates yet another application of the invention, namely a lithography system in which settling time is reduced by using control systems according to the invention.

FIGS. 9 and 10 illustrate experimental and analytical results obtained using MIMO motion according to the invention.

### DETAILED DESCRIPTION

The present invention proposes, in one embodiment, a motion control system that optimally governs the motion of a structure. The motion can be conceptualized in terms of initial and final coordinates, i.e., movement from point (x₁, y₁, z₁) to (x₂, y₂, z₂). The position coordinates can be defined either absolutely or relatively. Additionally, one might specify the velocity and/or acceleration at each of these points and at intermediate points or per a defined function in between. The motion control system employs a controller which, in one embodiment, is a controller generated using Linear-Quadratic-Gaussian (LQG) problem formulation, though other well-known methods, such as H-infinity or μ-synthesis, could also be used. The controller may, optionally, be self-tuning to ensure accuracy and optimization of trajectories generated by the motion control system over time.

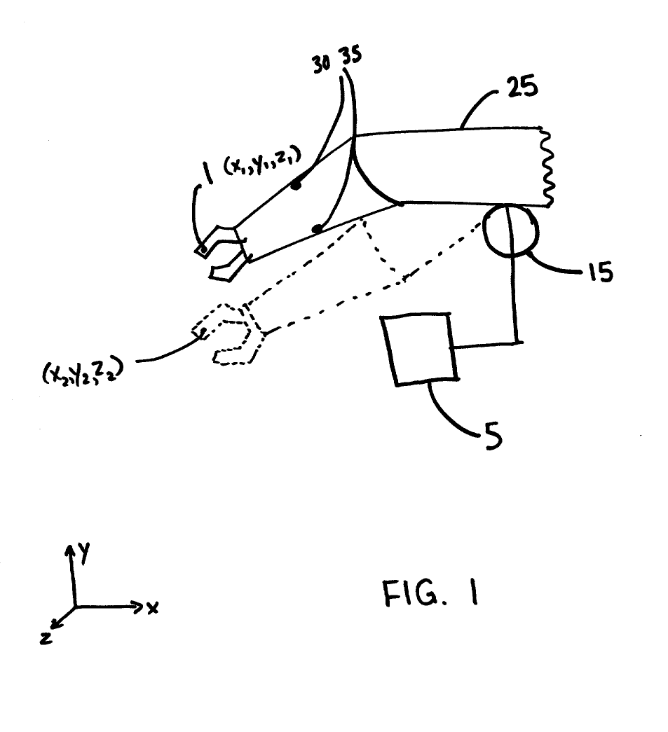

Referring first to FIG. 1, a robotic arm 25 is illustrated of the type that might be used to move a wafer or other component from one point to another during a manufacturing process. A positioning marker 1 on the arm 25 can be used as a reference point to indicate the position of the arm at any given point in time. The arm is shown electrically connected to a control system 5 which monitors the position of the marker 1, generates a desired motion for the marker 1 (and thus the arm 25), calculates the optimal motion controller that will govern the movement of the arm 25, and sends “start” and “stop” commands to the motor or servo 15 that controls motion of the arm 25. The motor referenced herein could be, for example, a direct drive rotary motor, a voice coil motor, a linear piezoceramic motor, or a servo motor. For the sake of simplicity, the example shown in FIG. 1 illustrates the movement of the marker 1 in one direction only (shown as the “y” direction), but one skilled in the art will appreciate that a combination of motors or servos could be used to move the marker 1 in other axial directions, or in more than one axial direction, as can be derived by breaking any given motion into x-, y-, and z-components.

A control system 5 for such an arm might, optionally, take into account both flexible and rigid body deformation characteristics of the arm 25. The control system might, for example, control the absolute position of the marker by compensating for vibrations in the arm due to excitation of the flexible body characteristics of the arm. The control system 5 also might account for the presence of other objects near, or in the path of, the arm's path of motion. One way of predicting, or compensating for, the structural behavior of such an arm in motion would be to employ actuator/sensor pairs, such as can be constructed using QuickPack® assemblies manufactured and sold by Active Control eXperts, Inc. of Cambridge, Mass. Of course, other types of sensors could be used to gather information, such as linear variable displacement transducers, accelerometers, and laser displacement instruments, to practice the invention. Thus, as an initial step in generating an optimal controller according to the present invention, the control system might activate an actuator positioned on the arm 25 and measure the response of the actuator's motion using a sensor. Information obtained in this manner could be used to generate or tune the optimal motion controller.

When the arm 25 is in use, the position marker 1 starts at location (x₁, y₁, z₁). A trigger is detected by the control system 5, based upon which the control system 5 selects an appropriate action, such as moving the arm 25. The trigger event could, for example, be completion of a task by another piece of equipment in the manufacturing process, an operator input signal, or the mere passage of time. The control system 5 generates a desired motion for the arm 25 and, depending on the complexity and capabilities of the control system 5, accounts for other factors which will impact the path and timing of the arm's motion. The phrase “desired motion” is intended to mean the information, such as state parameters or rules, used to describe the controlled action of the structure. Once a desired motion is generated, the anticipated movement and timing are passed to a module in the control system 5, such as a linear filter, which then applies a mathematical controller to optimize the motion of the arm 25. The optimized desired motion of the arm 25 is calculated by the control system 5. The calculation of the optimal motion controller can be as simple or as complex as desired. Thus, a simple controller might calculate just the spatial path of least distance, whereas a more complex controller might take into account several state parameters, or combinations thereof, such as acceleration, deceleration, the presence of other arms or equipment in the arm's path of motion, static and dynamic structural characteristics of the arm 25 and motor/servo 15 and other variables and data. Once the optimal motion controller is calculated, the control system 5 issues a “start” command to motor/servo 15, which, in turn, causes the arm to move in an optimal manner to (x₂, y₂, z₂).

During the movement from (x₁, y₁, z₁) to (x₂, y₂, z₂), the optimal motion controller could, optionally, be tuned to take into account disturbances and other (potentially unseen) factors encountered by the arm 25 while in motion. Thus, accelerometers 30 and 35 could be attached to various points of the arm 25, or even at the position marker 1. While accelerometers are called out here, other sensors for measuring other physical conditions, such as temperature, strain, position, and/or other information, could be used without departing from the scope of the invention. Accelerometers 30 and 35 could be used to ensure that the arm 25 is moving as predicted by the optimal motion controller. To the extent arm 25 encounters factors that prevent its optimal motion, a new optimal motion controller could be calculated to take these new factors into account and return the arm 25 to an optimal motion path.

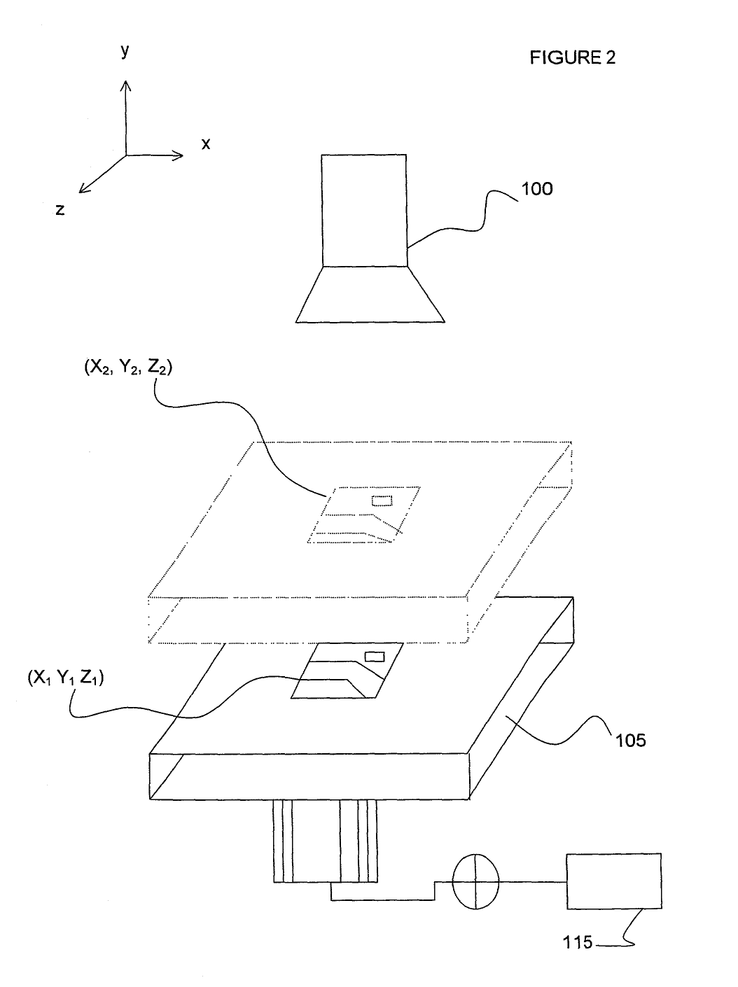

Another application of the present invention is illustrated in the metrology context. Referring now to FIG. 2, a precision assembly stage 105 is illustrated of the type designed for 300 mm wafers. Such stages are typically used by original equipment manufacturers (“OEMs”) in wafer metrology and inspection equipment. The stage shown may be air-bearing, with linear motors and a gantry. In this example, the motion control system is used to position the stage precisely with respect to a camera 100 of the type used to conduct visual inspection of semiconductor chips. While the example provided herein illustrates positioning a stage with respect to a camera, one of ordinary skill will appreciate that the control systems of the invention could be used to position any two structures (or points representing those structures) precisely relative to one another. In FIG. 2 the stage begins at coordinates (x₁, y₁, z₁), where these coordinates are defined in relation to the camera 100. Again for the sake of simplicity, the stage is shown as being moved from a first distance from the camera 100 in the y-direction to a second distance from the camera 100 in the y-direction. One of ordinary skill will appreciate that the stage could be moved in either the x-direction, the z-direction, or some distance in all three axial directions.

As in FIG. 1, when a control system 115 receives a trigger, it generates a desired motion which is then optimized according to an optimal motion controller. As discussed previously, the motion controller may be tuned during the actual motion to ensure a near-continuously optimal desired motion for the stage 105. The optimal motion controller, in one complex embodiment, would take into account the focusing speed of the camera 100.

Notably, the control systems described in FIGS. 1 and 2 are not required to be stand-alone units. Thus, control systems according to the invention, by way of reference to FIG. 1, could take the form of a separate unit between, for example, an existing robot-arm control unit (which generates, for example, the desired motion) and the robot-arm, be integrated into an existing robot-arm control unit, or be connected only to an existing robot-arm control unit as an additional processor. Of course, optionally, the control system of the invention could also be used to perform the control functions typically performed by the existing robot-arm control unit, and thus replace the existing unit entirely.

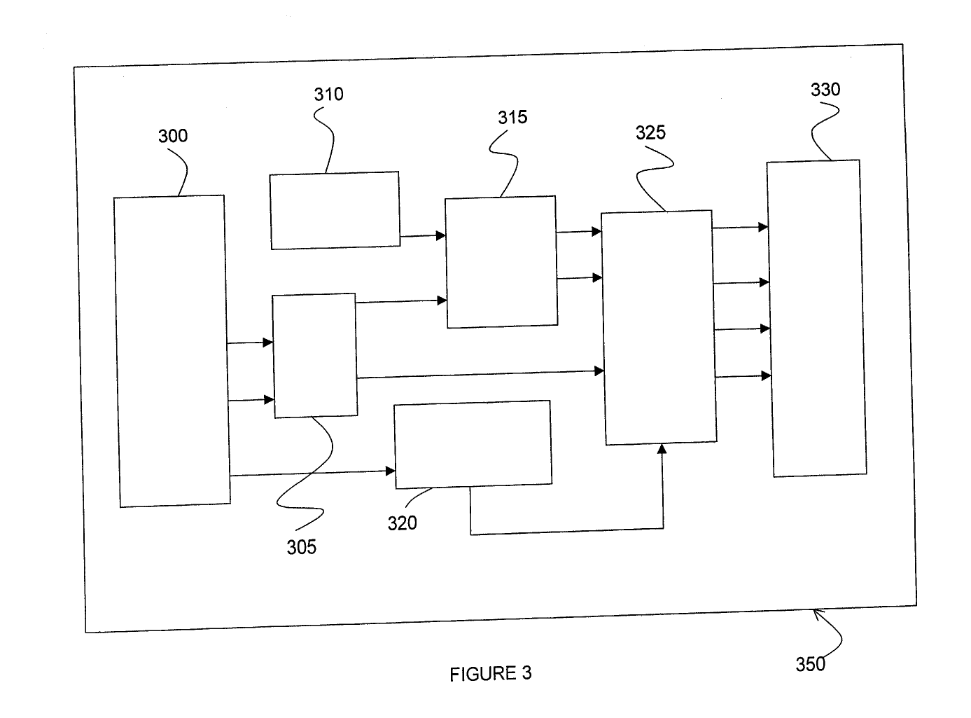

FIG. 3 provides one possible architecture of the control hardware and software modules in a control system 350 according to the invention. A signal source processor 300 receives input from sensors, such as the accelerometers 30 and 35 in FIG. 1, and generates, in conjunction with an optional motion module 310, a desired motion for the motion to be implemented. Once a trigger 305 occurs, such as an operator input to begin movement of a structure, the trigger causes information from the signal source to be processed and sent to, for example, a linear, time-invariant, multivariable state space controller 325. The state space controller 325 may be capable of controlling as many as 32 or more states and may have an execution time on the order of 400 nanoseconds, though one of ordinary skill will appreciate that execution time will vary depending upon processor speed and the complexity of the calculations performed. The controller 325 which, as is described below, contains a behavioral model of the structure being controlled, may be generated in conjunction with the initial design and manufacture of the structure to be controlled. In order to produce an optimized desired motion, which takes into account one or more state parameters independent of the distance and timing calculated by the motion module 310, the controller 325 is applied to the inputted information received from motion module 310, the signal source processor 300, and, optionally, information regarding the trigger 305. The state space controller 325 generates the optimized desired motion, which is then passed to the signal output module 330. The signal output module 330 generates signals which, referring again to FIG. 1, can be used by a motor/servo 15 to instigate, stop, or modify the motion of the structure to be controlled in a way so as to implement the optimal desired motion generated using the controller 325. Optionally, other modules, such as a detrending module 315 or gain scheduling module 320, may be added to enhance system performance. A detrending module 315 could remove low-bandwidth trigger signals, and thus effectively modulate system noise. Such a module also creates a certain degree of fault-tolerance of triggers and could be used to eliminate the need for detailed command information from, for example, an existing robot-arm control unit. The gain scheduling module 320 allows for control gains to vary in response to changing system dynamics and control objectives that may, for example, vary with overall system configuration, geometry, mass distribution, and/or position of the structure being controlled.

As mentioned above, the controller 325 optionally may be tuned to ensure its optimization (and thereby ensure the optimization of the desired motion to which the controller 325 is applied). Generally, the process of tuning entails creating a system model based on state parameters representative of structural and behavioral indicia, and then adjusting the model based on certain selected measured responses. Such responses may, for example, be the response detected between sensor-actuator pairs. Thus, the tuning described below may be used to assure generation of an accurate initial controller 325, or to tune an existing controller over time. Three illustrative hardware systems are described herein that may be used to tune the optimization of generated desired motion.

In a first embodiment, tuning is performed using feedback control done by a digital signal processor (DSP)-based system, in which the controller 325 is on the DSP. The tuning capability is added by attaching the DSP to a tuning host computer via an appropriate interface. System identification data (the data upon which the model used in controller 325 is based) is passed back to a controller on the host computer that performs the model tuning and control redesign and passes the new controller back to the DSP. A second embodiment places all functionality for tuning and control redesign on the DSP. A third embodiment includes a second processor located on the DSP board or a daughter board attached to the DSP-based system. Of course, one possessing ordinary skill in the art will appreciate that other hardware configurations that remain within the scope of the invention are possible. For example, in the first embodiment, the host computer could be located off-site and thus the data transfer between the host and the DSP could occur over a communications link, such as an ethernet connection or through the use of a product like CymerOnLine™, also offered by Cymer, Inc.

Once the model has been updated, it may be desirable to update the controller gains. This is usually done by constructing and solving an optimal control problem, such as is described by a properly formulated Linear Quadratic Gaussian (LQG) problem. A compensator is generated during the solution of this problem by minimizing the following equation:

J=E└x^{T}Qx+u^{T}Ru+x^{T}Nu┘

when the system is subject to Gaussian white noise on disturbances and sensors. In this equation, x is a state vector of the system, u is a vector of control inputs, and Q, R, and N are state and control weighting matrices. E[ ] is the expectation operator.

The information used to create the optimal control problem used by the controller 325 may, for example, be actuator to sensor information. Additionally, it may be desirable to standardize the optimal control problem formulation as much as possible. Toward this end, the inventors have found it possible to reduce specifying the optimal control problem to specifying a finite set of values. A computer program implementing the tuning algorithm reads these values from a file or an alternate communications channel at run-time. Advantageously, this permits a designer to quickly make changes to the optimal control problem formulation, and to observe the effect of these changes in the actual system, without having to recompile the program. This approach is in some regards analogous to being able to download the coefficients specifying a controller at run time.

In practice, keeping with the LQG method by way of example, the design problem that is solved to obtain the controller 325 is typically specified by describing, or at least estimating, the input/output behavior from all disturbances (including sensor noise), w, and controller outputs, u, to all performance variables (including controller penalty), z, and controller inputs, y. In general, this is done by specifying a state space filter which maps disturbances and controller inputs to performance variables and controller outputs. This filter includes frequency weighting filters used by the designer to adjust the properties of the controller returned by the LQG algorithm as well as the plant dynamics.

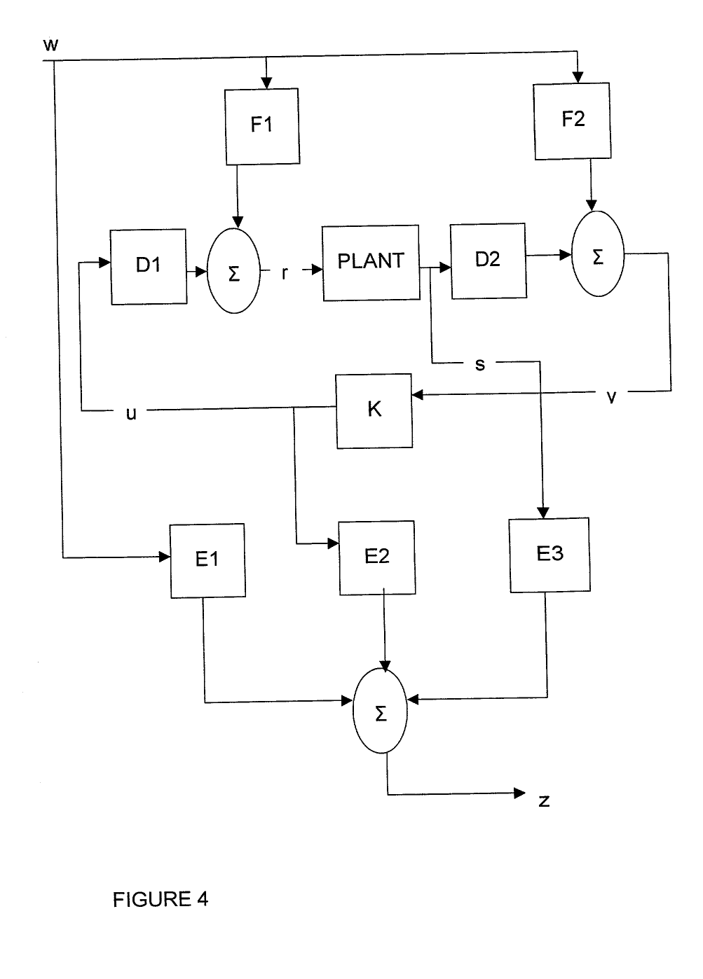

For automated controller design, it is usually necessary to separate the plant dynamics from the frequency weighting filters. FIG. 4 shows the most general way in which an actuator to sensor model can be combined with weighting sensors to produce a full LQG problem specification. This figure uses filters E₁, E₂, E₃, D₁, D₂, F₁, and F₂ to specify the relationship between disturbances, w, performance variables, z, controller inputs, y, controller outputs, u, plant inputs, r, and plant outputs, s. Mathematically these relationships are expressed as:

z=E₁w+E₂u+E₃s

r=F₁w+D₁u

y=F₂w+D₂s

or in more compact form:

$$[ \begin{matrix}z \\ r \\ y\end{matrix} ] = \underbrace{[ \begin{matrix}{E}_{1} & {E}_{2} & {E}_{3} \\ {F}_{1} & {D}_{1} & 0 \\ {F}_{2} & 0 & {D}_{2}\end{matrix} ]}_{F} [ \begin{matrix}w \\ u \\ s\end{matrix} ]$$

The identified actuator to sensor model and the filter, F, completely describe an LQG problem formulation, and since the solution of the LQG problem is unique, the filter, F, completely describes a mapping from an identified model to a controller. The filter, F, is thus universally applicable, obviating the need for programming a new filter for each configuration of equipment, thus saving time, money, processing power, and computer programmer time. Indeed, to specify this map, the designer only needs to provide the coefficients, i.e., a vector of numbers, describing a state space model of the filter. Alternatively, instead of updating the controller gains as described above, the control parameters themselves may be adjusted using techniques such as non-linear optimization to minimize a more general set of cost functions:

J=F(\hat{θ},θ_{c})

where \hat{θ} is the vector of model parameters, and θ_{c} is a vector of controller parameters. An example of this is multi-model optimization, where the LQG cost function is optimized simultaneously for several different actuator to sensor models. This approach provides a controller which is less sensitive to variations. The multiple models can either be obtained directly from the plant by performing system identification with the plant in different configurations, or it can be obtained by applying parametric variations to a single identified model (such as varying modal frequencies).

Another example where applying non-linear optimization to adjust the control parameters is the case when the LQG problem is as specified above, but the controller order is fixed to be less than the total number of plant and filter states. In this case, the normal LQG solution (which returns a controller with order equal to the total number of plant and filter states), is not preferred. Instead, the optimal controller is found by using iterative search methods.

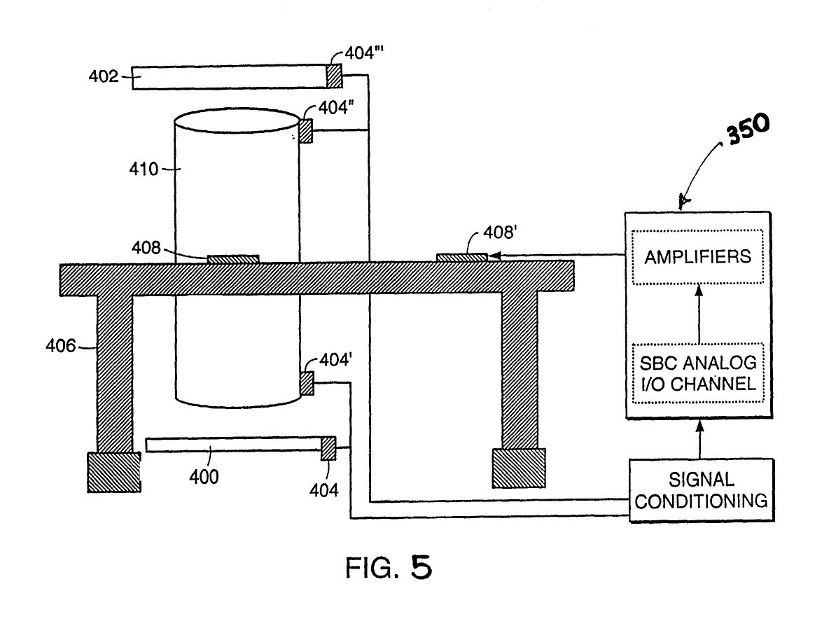

FIG. 5 shows an embodiment of the invention as used in a fabricating system. In this embodiment, the fabricating system comprises a wafer stage 400, a reticle stage 402, laser interferometers 404, 404′, 404″, and 404′″ with X&Y mirrors, and a support structure 406. The support structure 406 supports a lens assembly 410. The interferometers 404, 404′, 404″, and 404′″ are located on the wafer stage 400, the reticle stage 402, and on the lens assembly 410. Mounted on the support structure 406 are two actuators 408 and 408′ comprising, for example, an electroactive element. Each of the actuators 408 and 408′ are in electrical communication with a circuit. Signals from the interferometers 404, 404′, 404″, and 404′″ are relayed to the control system 350 through a single-board-computer (“SBC”) analog I/O channel and amplifiers. Motion control system 350, in turn, sends commands to the actuators 408 and 408′, which, in response, can control motion and vibration within the fabricating system. By controlling motion and vibration within the fabricating system, the accuracy of the placement and absolute size of the metallized traces in the semiconductor on a wafer stage may be improved. Alternatively or in addition, the through-put of the fabrication system may be increased without decreasing accuracy by, for example, decreasing the dynamic and/or vibratory settling of the structure being controlled. This could, for example, be accomplished by identifying settling time as a state parameter to be minimized by the control system 350.

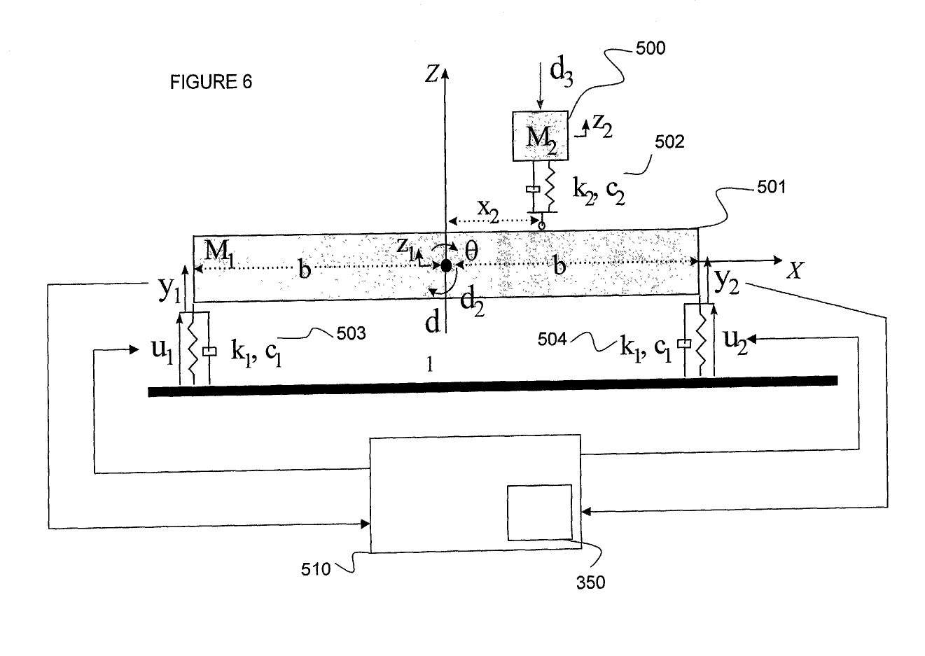

As mentioned above, the present invention can be used to control the motion of wafer stages in lithography tools that have multiple degrees of freedom. FIG. 6, for illustrative purposes, provides a simplified two-dimensional physics model of a wafer stage base 501 and a wafer stage 500. One of ordinary skill will appreciate that the example of FIG. 6 could be readily generalized to a real system in which three-dimensions are of concern.

The masses of the stage and the base are relatively similar and each weigh approximately 200 kg. The wafer stage base measures approximately 1 m in length×1 m in width×0.15 m in thickness. The wafer stage measures approximately 1.25 m in length×0.5 m in width×0.5 m in thickness. Actuator (motor) inputs are represented by the symbol uᵢ, where i represents a specific voice coil motor. Alternative actuators are contemplated which include linear piezoceramic motors. Sensor outputs are represented by yᵢ, where i represents a laser displacement measurement that is collocated with the voice coil input. Alternative output sensors (including linear variable displacement transducers (LVDT's), accelerometers) and sensor locations (nearly co-located, sufficiently colocated) are contemplated for this example. Disturbances (represented by dᵢ) to the system include on-board (including motors, fans, and articulating arms) and off-board disturbances (including ground vibrations, air currents, thermal fluxuations).

The wafer stage 500 is supported on the wafer stage base by a pneumatic system 502 comprised of airbearings. This airbearing is provided to allow the wafer stage 500 to move nearly frictionless with respect to the wafer base stage 501. The wafer stage base 501 is supported on the ground by a pneumatic system of airmounts 503 and 504. The physical properties of the airmounts are represented by a spring (k1) and a dashpot (c1). The physical properties of the airbearing are represented by a spring (k2) and a dashpot (c2). The pneumatic system 503 and 504 offsets the weight of the wafer stage 500 and the wafer stage base 501 with respect to the ground. The pneumatic system 503 and 504 provides a low-frequency (approximately several Hertz) control of the plunge and tilt of the wafer stage base 501. Additional high frequency control of the base stage 501 is provided by the voice coil motors u1, u2. A microprocessor system 510 contains a motion control system, like system 350 in FIG. 3, and is typically used to sense the outputs and command (actuate) the inputs as a function of the control algorithm implemented by the microprocessor system 510. The system 510 attempts to move or position the wafer stage 500 relative to the wafer stage base 501 based upon the requirements of the lithography process and the output of the control system 350 contained therein. For example the lithography system may require a constant scanning motion of the wafer stage 500 to be performed during exposure of an image on a wafer. Alternatively, the lithography system may command a rapid acceleration of the wafer stage 500 to re-locate the wafer stage to an alternative position. The wafer stage 500 would be required to make these movements to meet requirements of speed, accuracy, and/or settling time. Settling time refers to the time required to achieve a given position within some allowable variation of the absolute position. These prescribed motions with very high accelerations (up to 2 g), create significant reaction forces that are transmitted to the base. In addition, these motions cause the compound center of gravity of the base stage system to rapidly change position. Currently base stabilization control is accomplished by the microprocessor system 510 through the implementation of six independent single-input, single-output (SISO) controller. Typically a SISO controller is used for each degree of freedom in the specific application. Typical three-dimensional systems could possess six degrees of freedom for each independently controlled system component or stage. SISO controllers are generally susceptible to variations in the location of the stage relative to the base. This is because the individual controller is not provided with additional output information. The system illustrated in FIG. 6, uses a multi-input, multi-output controller (MIMO) to achieve better performance than a SISO implementation even with variations of the location of the stage relative to the base. In a MIMO implementation the control is accomplished with knowledge of the output and input of more than one sensor (output) and actuator (input). Additionally, MIMO control architecture allows for the implementation of modern control techniques, including but not limited to, linear quadratic Gaussian (LQG), H-infinity, and mu synthesis. These techniques cannot be efficiently combined with SISO architecture.

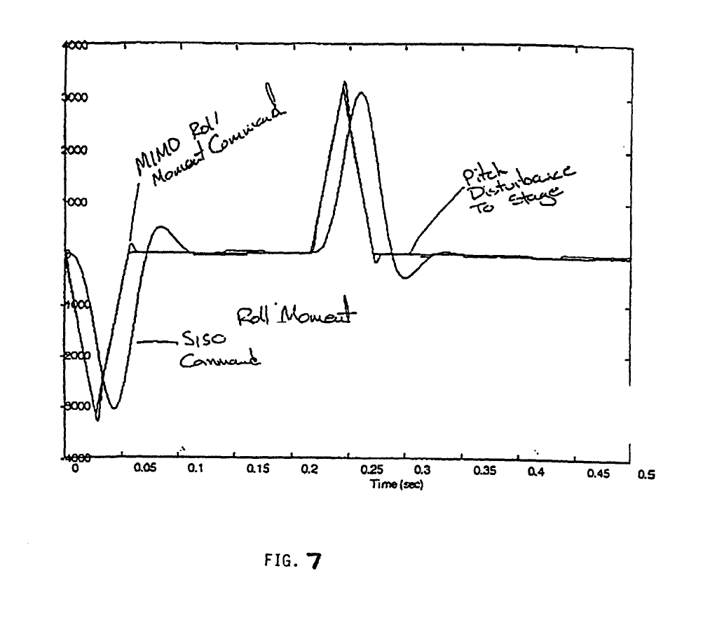

FIG. 7 illustrates how well a MIMO controller can follow (indicated by a roll moment command) a commanded input (stage pitch disturbance) to the roll moment compared with typical performance of a SISO controller (indicated by Nominal roll moment command). The MIMO controller tracks very closely to the disturbance, meaning that it is capable of reacting very quickly to a disturbance force and reject it from the system. When combined with a motion control system of the invention, the MIMO controller could improve some combination of the speed, accuracy, or throughput of the stage.

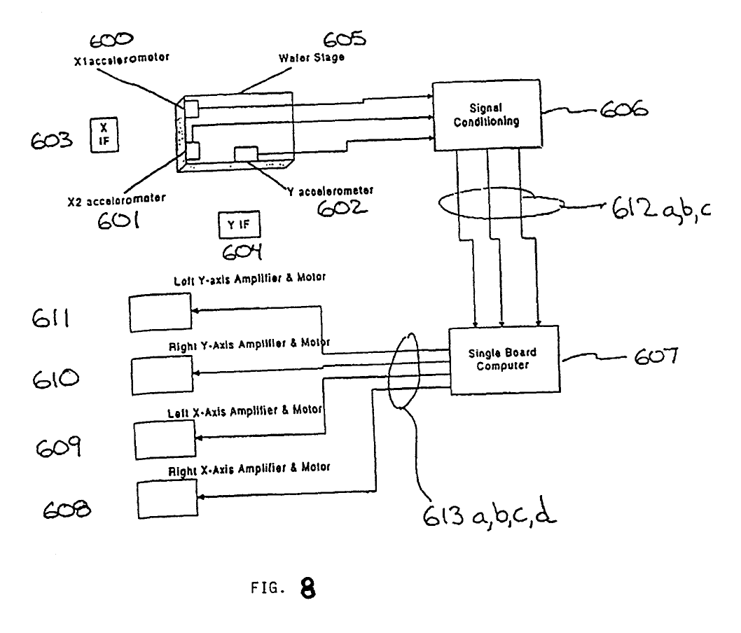

In another embodiment of a stage control application in a lithography system it was desired to decrease the settling time for a system to accurately track a commanded position. FIG. 8 illustrates the block diagram that describes the embodiment. In this embodiment, three accelerometers 600, 601, 602 used as the sensor for feedback control. 600 and 601 represent accelerometers that measure x-axis acceleration. 602 represents a single accelerometer that measures y-axis acceleration. These measurements which are generally proportional to the acceleration are sent to a signal conditioner 606 that buffers the signals and then sends the signals which are generally proportional to the acceleration of the stage to a single board computer 607 which may contain, or be in data communication with, a control system such as control system 350. A representative single board computer is Model SBC67 supplied by Innovative Integration Inc. with offices in Simi Valley, Calif. This processor is a high performance stand-alone digital signal processor single board computer featuring analog input and output capability. The voltage signals 612a, b, c are fed into analog inputs. These analog inputs are then converted to digital signals that the processor then sends to the control system 350. After optimization, the control system 350 outputs a set of digital signals which are then converted to analog output signals 613a, b, c, d. These output signals are then applied to each of the four motors 608, 609, 610, 611. Motors 608 and 609 are x-axis motors that control the position of the stage in the x-axis. Motors 610 and 611 are y-axis motors that control the position of the stage in the y-axis. X-axis interferometer 603 and Y-axis interferometer 604 are used to measure the x and y position of the stage relative to the base of the stage (which is not depicted here for simplification).

The filter (feedback control algorithm) may be designed to ensure that the motor control signals do not exceed the motor or motor amplifier limits. Motor control signals in the closed feedback loop are proportional to the accelerometer 600, 601, 602 signals associated with acceleration of the stage. Control design can be accomplished by first creating a state-space plant model from transfer function data using the Smart IDTM system identification software package commercially available from Active Control Experts, Inc. The filter (or controller) was then designed through computer simulation and application of techniques discussed in Fanson and The Control Handbook, William S. Levine, Editor, CRC Press, 1996.

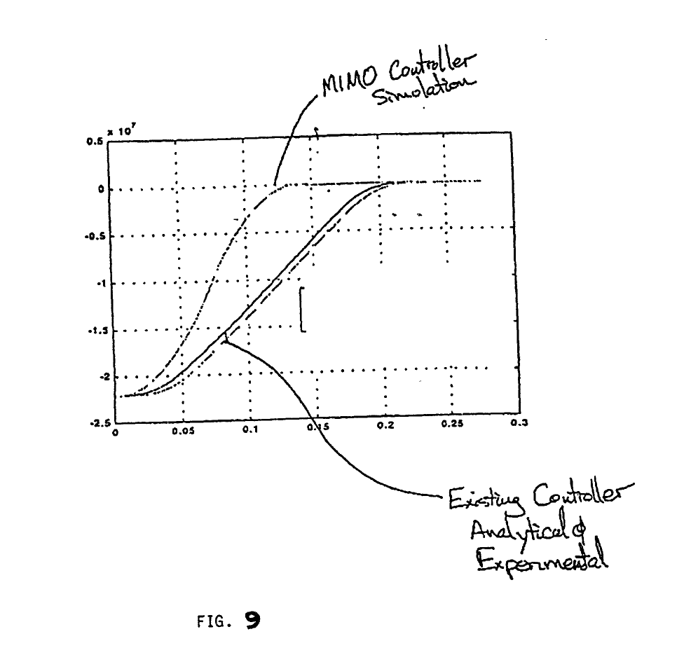

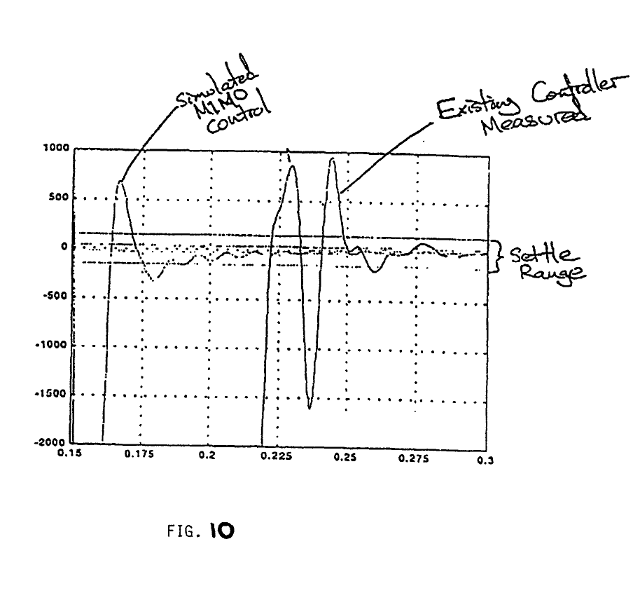

FIGS. 9 and 10 represent experimental and analytical results of the MIMO control applied in the embodiment of FIG. 8. The MIMO results are compared with results in which multiple SISO loops are instead utilized. FIG. 10 illustrates the results when zoomed in between the 0.15 s and 0.30 s time period. This figure illustrates that the MIMO control settles to within the settle range (approximately 100 on the y-axis of the graph) by approximately 0.19 s while the SISO (existing controller) only achieves this performance at approximately 0.26 s. This represents an improvement in settling time of approximately 30%.

### Equivalents

While the invention has been particularly shown and described with reference to specific embodiments, it should be understood by those skilled in the art that various changes in form and detail may be made therein without departing from the spirit and scope of the invention as defined by the appended claims.

What is claimed is:

1. A control system for governing the motion of a structure, comprising:
a processor capable of generating at least one state parameter which specifies the desired motion of the structure;
a filter module in data communication with the processor, the filter serving to control the values of the at least one state parameter generated by the processor and to update the values as a function of time; and
a signal output module which generates signals that correspond to the at least one state parameter updated by the filter module,
wherein the motion of the structure implemented based upon the signals from the signal output module of the structure is specified by a variation in the at least one state parameter, and where the specific value of the at least one state varies as a function of time in an optimal manner.

2. A control system according to claim 1, wherein the at least one state parameter is calculated using data concerning the absolute position of the structure.

3. A control system according to claim 1, wherein the at least one state parameter is calculated using data concerning the relative position of the structure.

4. A control system according to claim 1, wherein the at least one state parameter is selected from the following group of parameters: position of the structure as a function of time, velocity of the structure as a function of time, and acceleration of the structure as a function of time.

5. A control system according to claim 1, wherein the filter module includes a mathematical controller which implements a modern control technique selected from LQG, H-infinity, and μ-synthesis.

6. A control system according to claim 1, wherein the structure being controlled is a lithography stage or base.

7. A control system according to claim 1, wherein the structure being controlled is a stage of a metrology tool.

8. A control system according to claim 4, further comprising a sensor used to gather data concerning the at least one state parameter, the sensor selected from the group of sensors consisting of: a linear variable displacement transducer, and accelerometer, and a laser displacement instrument.

9. A control system according to claim 1, wherein the desired motion of the structure is specified by the output module signals applied to a motor.

10. A control system according to claim 10, wherein the motor is selected from the group of motors consisting of: a direct drive rotary motor, a voice coil motor, a linear piezoceramic motor, and a servo motor.

11. A control system according to claim 1, wherein the control system serves to reduce vibration in the structure.

12. A control system according to claim 1, wherein the at least one state parameter comprises a combination of position of the structure, velocity of the structure, and acceleration of the structure.

13. A control system according to claim 12, wherein the filter module controls the at least one state parameter in a manner effective to reduce vibratory motion of the structure.

14. A control system according to claim 12, wherein the filter module controls the at least one state parameter in an optimal manner as a function of time.

15. A control system for governing the motion of a structure, the structure acting as part of an overall apparatus, comprising:
at least one sensor for collecting data regarding the structure;
at least one processor that generates an initial set of rules according to which the structure could move;
at least one optimization module which optimizes the initial set of rules generated by the processor by applying a controller, thereby generating a second set of rules according to which the structure will move; and
a signal output generator used to cause the structure to move according to the second set of rules,
wherein the controller is tuned using the data collected by the at least one sensor.

16. A control system according to claim 4, further comprising an actuator, and wherein the data collected by the at least one sensor concerns the response of the structure to activation of the actuator.

17. A control system according to claim 15, wherein the optimization module generates the controller, the controller being generated using non-linear optimization techniques.

18. A control system for governing the motion of a structure, the structure acting as part of an overall apparatus, comprising:
at least one sensor for collecting data regarding the structure;
at least one processor that generates an initial set of state parameters according to which the structure could move;
at least one optimization module which optimizes the initial set of state parameters generated by the processor by applying a controller, thereby generating a second set of state parameters according to which the structure will move; and
a signal output generator used to cause the structure to move according to the second set of state parameters,
wherein the controller is tuned using the data collected by the at least one sensor.

19. A method for governing the motion of a structure, comprising the steps of:
calculating a first desired movement parameter;
optimizing the first desired movement parameter, thereby generating a second desired movement parameter; and
causing the structure to move according to the second desired movement parameter, thereby causing the structure to move in an optimal fashion.

20. A method for optimizing an existing set of parameters according to which a structure will move, comprising the steps of:
gathering information regarding the behavior of the structure;
generating a controller based upon the gathered information;
applying the controller to the existing set of parameters to create a new set of parameters which will cause the structure to move in an optimal fashion; and
generating an output signal to the structure based on the new set of parameters, the output signal intended to cause the structure to move according to the new set of parameters.
